(19) United States
(12) Patent Application Publication
(10) Pub. No.: US 2026/0194473 A1
(43) Pub. Date: Jul. 9, 2026

(54) MEASUREMENT SYSTEM AND METHOD BASED ON FEMTOSECOND LASER

(71) Applicant: KOREA ADVANCED INSTITUTE OF SCIENCE AND TECHNOLOGY, Daejeon (KR)

(72) Inventors: Young-Jin KIM, Daejeon (KR); Dae Hee KIM, Daejeon (KR); Jun Hyung PARK, Daejeon (KR)

(21) Appl. No.: 19/434,268

(22) Filed: Dec. 29, 2025

(30) Foreign Application Priority Data
Jan. 8, 2025 (KR) 10-2025-0002567
Nov. 25, 2025 (KR) 10-2025-0180177

(51) Int. Cl. G01N 21/95; G01B 11/06; G01N 21/3563; G01N 21/359

(52) U.S. Cl. CPC G01N 21/9505; G01B 11/06; G01N 21/3563; G01N 21/359; G01N 2201/06113; G01N 2201/105

(57) ABSTRACT

A measurement system comprises a femtosecond laser; an optical mask configured to block a central portion of a beam output from the femtosecond laser to generate an annular beam; an objective lens configured to focus the annular beam onto a measurement target; a scanner configured to perform depth-direction scanning of the measurement target by controlling a focal point of the annular beam; a detector configured to detect third-harmonic generation (THG) signals generated from the measurement target during the depth-direction scanning; and a computing device configured to calculate a physical thickness of the measurement target using a distance between two points at which the THG signals are detected.

### CROSS-REFERENCE TO RELATED APPLICATIONS

This application claims priority to and the benefit of Korean Patent Application No. 10-2025-0002567 filed with the Korean Intellectual Property Office on Jan. 8, 2025 and Korean Patent Application No. 10-2025-0180177 filed with the Korean Intellectual Property Office on Nov. 25, 2025, the entire contents of which are incorporated herein by reference.

### BACKGROUND

### (a) Field

The present disclosure relates to non-destructive measurement.

### (b) Description of the Related Art

In the semiconductor industry, silicon wafers serve as the primary substrate for microelectronic devices such as transistors and integrated circuits. In particular, ultra-thin wafers offer high flexibility and integration, for which precise measurement of wafer thickness is essential.

Electrical capacitive sensors and optical confocal sensors have been widely used to measure the thickness of silicon wafers. Wafer thickness can be measured by detecting the geometrical position of the wafer with respect to two probes located at the top and bottom, but this dual-probe system has the disadvantage of being very sensitive to the relative lateral position and angular alignment of the two probes. On the other hand, since near-infrared (NIR) wavelengths can pass through silicon wafers, a simple single optical probe can be implemented using NIR light. Therefore, optical interference probes can provide a higher accuracy over the dual probes. However, they still lack of depth selectivity and can be inaccurate due to surface coating layers or multiple reflections inside the wafer. In particular, silicon wafers have the limitation of being opaque in the visible and ultraviolet regions.

### SUMMARY

The present disclosure relates to a measurement system and method based on femtosecond laser.

The present disclosure relates to a system and method for non-destructively measuring wafer conditions such as a wafer thickness, by third-harmonic generation (THG) using a femtosecond laser.

A measurement system includes: a femtosecond laser; an optical mask configured to block a central portion of a beam output from the femtosecond laser to generate an annular beam; an objective lens configured to focus the annular beam onto a measurement target; a scanner configured to perform depth-direction scanning of the measurement target by controlling a focal point of the annular beam; a detector configured to detect third-harmonic generation (THG) signals generated from the measurement target during the depth-direction scanning; and a computing device configured to calculate a physical thickness of the measurement target using a distance between two points at which the THG signals are detected.

The computing device may be configured to convert the distance between the two points at which the THG signals are detected into the physical thickness using a ray incidence angle and a refraction angle.

The computing device may be configured to generate stacked images based on intensity of the THG signals detected through the depth-direction scanning.

The computing device may be configured to inspect internal defects of the measurement target using the stacked images.

The annular beam may be designed according to a ratio of a rim width to a radius of a Gaussian beam.

A center wavelength of the femtosecond laser may be determined according to a transmittance of the measurement target.

When the measurement target is a silicon wafer, the femtosecond laser may be output a beam in a near-infrared (NIR) band.

A wafer measurement method includes: blocking a central portion of a beam output from a femtosecond laser to generate an annular beam; focusing the annular beam onto a surface of a wafer and performing depth-direction scanning of the wafer by controlling a focal point of the annular beam; detecting third-harmonic generation (THG) signals generated from the wafer during the depth-direction scanning; and calculating a physical thickness of the wafer using a distance between two points at which the THG signals are detected.

The calculating the physical thickness may comprise converting the distance between the two points at which the THG signals are detected into the physical thickness using a ray incidence angle and a refraction angle.

The wafer measurement method may further include: generating stacked images based on intensity of the THG signals detected through the depth-direction scanning.

The wafer measurement method may further include: inspecting internal defects of the wafer using the stacked images.

The annular beam may be designed according to a ratio of a rim width to a radius of a Gaussian beam.

A center wavelength of the femtosecond laser may be determined according to a transmittance of the wafer.

When the wafer is a silicon wafer, the femtosecond laser may output a beam in a near-infrared (NIR) band.

According to some embodiments, the present disclosure addresses the limitations of conventional wafer thickness measurement technologies, such as insufficient depth selectivity, system complexity, and limited measurement accuracy, and provides non-destructive and high-precision measurement of semiconductor substrates like silicon wafers.

According to some embodiments, nanometer-scale high-precision measurement may be achieved through third-harmonic generation using a near-infrared femtosecond laser. The present disclosure may improve surface sensitivity, thereby enabling effective wafer inspections of defects, delamination, particle contamination, cracks, and the like. Accordingly, the present disclosure may be effectively applied for quality control and internal defect diagnosis in semiconductor manufacturing.

According to some embodiments, the non-destructive and non-contact thickness measurement may prevent substrate damage, and in-line measurement may improve the efficiency of production processes.

According to some embodiments, system optimization with an annular beam design may reduce optical distortion to improve measurement precision and reproducibility. This versatility may extend the application of the technology beyond silicon wafers to various optical materials such as sapphire and MgO.

According to some embodiments, the present disclosure may significantly contribute to quality control and productivity improvements in semiconductor manufacturing processes.

### BRIEF DESCRIPTION OF THE DRAWINGS

FIG. 1 is a diagram illustrating a measurement system according to an embodiment.

FIG. 2 is a diagram illustrating an annular beam according to an embodiment.

FIG. 3 is a diagram illustrating the results of third harmonic wave generation according to an embodiment.

FIG. 4 is a diagram illustrating intensity images of third-harmonic generation (THG) signal acquired by depth directional scanning according to an embodiment.

FIGS. 5 and 6 are diagrams illustrating signal intensity variations acquired through depth-direction scanning, according to an embodiment.

FIG. 7 is a diagram illustrating detection of third-harmonic generation signal for thickness measurement of sapphire and MgO according to an embodiment

FIG. 8 is a diagram conceptually illustrating wafer inspection according to an embodiment.

FIG. 9 is a flowchart illustrating a thickness measurement method according to an embodiment.

### DETAILED DESCRIPTION OF THE EMBODIMENTS

Embodiments of the present disclosure are described in detail with reference to the accompanying drawings so that those of ordinary skill in the art to which the disclosure pertains may easily implement the present disclosure. However, the present disclosure may be implemented in many different forms and is not limited to the embodiments described herein. In the drawings, parts unrelated to the description are omitted for clarity, and similar reference numerals designate similar parts throughout the specification.

In the description, unless explicitly stated to the contrary, the word “comprise” and variations such as “comprises” and “comprising” should be understood to imply the inclusion of stated elements but not the exclusion of any other elements.

In the description, reference numerals and names are attached for convenience of explanation, and the devices are not necessarily limited to the reference numerals or names.

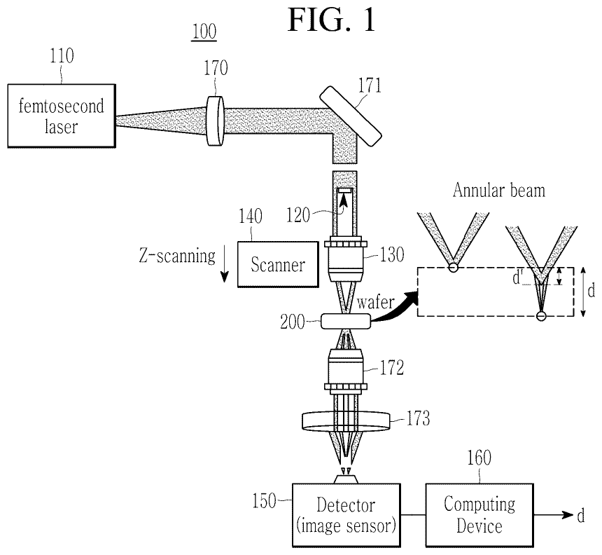

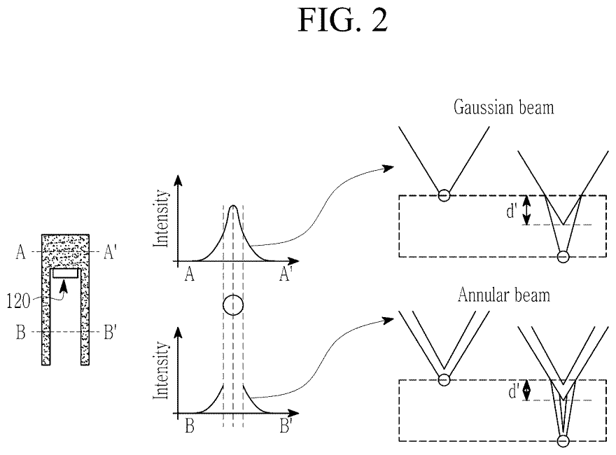

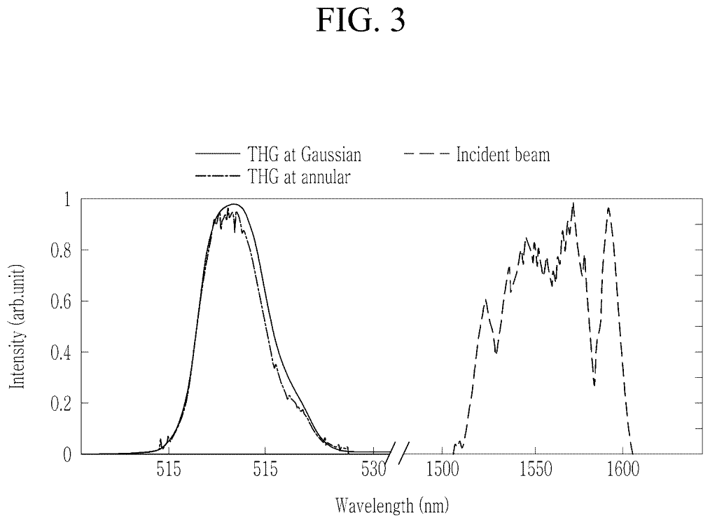

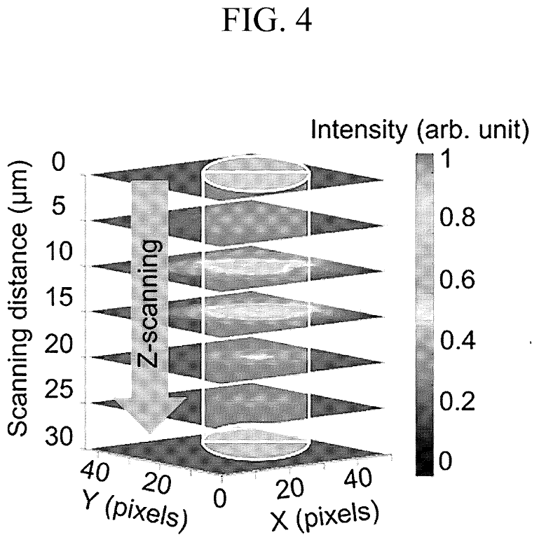

FIG. 1 is a diagram illustrating a measurement system according to an embodiment, FIG. 2 is a diagram illustrating an annular beam according to an embodiment, FIG. 3 is a diagram illustrating the results of third harmonic wave generation according to an embodiment, and FIG. 4 is a diagram illustrating intensity images of third-harmonic generation (THG) signal acquired by depth directional scanning according to an embodiment.

Referring to FIG. 1, a measurement system 100 is configured to non-destructively measure wafer conditions, such as a thickness of a measurement target, by third-harmonic generation (THG) using a femtosecond laser 110. Using the femtosecond laser 110 having a high peak power as a light source, third-harmonic generation (THG) may be induced at an upper surface, a lower surface, or inside the measurement target, and a thickness of the measurement target may be measured by detecting the THG signal. The measurement system 100 may also detect wafer conditions, such as defects, delamination, particle contamination, cracks, and like. In the following description, a method of measuring a thickness through THG using a femtosecond laser will be mainly described. Hereinafter, a wafer 200 will be described as an example of a measurement target.

The measurement system 100 may comprise a femtosecond laser 110, an optical mask 120 configured to generate an annular beam, an objective 130 configured to irradiate the annular beam onto a wafer 200, a scanner 140 for depth-direction scanning (z-scanning), a detector 150 configured to detect third-harmonic generation (THG) signals generated from the wafer 200, and a computing device 160 configured to determine wafer conditions, such as a wafer thickness, based on the THG signals. The measurement system 100 may further comprise optical components, such as a collimator 170 and a mirror 171, for directing the beam from the femtosecond laser 110 to the optical mask 120. The measurement system 100 may further comprise optical components, such as an objective lens 172 and a focusing lens 173, for directing a fundamental beam traversing the wafer 200 and the TGH signals generated from the wafer 200 to the detector 150.

The femtosecond laser 110 may generate ultrashort pulses having a duration of several tens to hundreds of femtoseconds, thereby providing a high instantaneous power (peak power). The center wavelength of the beam may be determined according to a transmittance of the measurement target. For example, a near-infrared band (e.g., 1550 nm band) that has high transmittance in silicon wafers may be used.

An annular beam may be used to improve measurement precision. The optical mask 120 may block the central portion of the beam output from the femtosecond laser 110 to generate the annular beam.

Referring to FIG. 2, a focused Gaussian beam has a wide range of incident angles, and thus a focal depth may vary due to optical aberrations. Therefore, for high-precision measurements, an input beam profile may be adjusted to obtain various average incident angles, and based thereon, the optical mask 120 may be fabricated to block the central portion of the Gaussian beam, thereby generating the annular beam.

Referring again to FIG. 1, the annular beam is focused onto a surface of the wafer 200 through the objective lens 130. The wafer 200 is scanned in a depth direction by the scanner 140. By performing depth-direction scanning by controlling a focal point of the femtosecond laser beam, an intensity of the THG signal may be measured as a function of depth in the wafer 200. Among nonlinear optical techniques for harmonic generation, third-harmonic generation occurs sensitively at a medium interface, that is, at the wafer surface. Therefore, the THG signals generated at an upper surface and a lower surface of the wafer 200 may be used for thickness measurement. In addition, internal conditions of the wafer 200, such as defects, delamination, particle contamination, and cracks, may be inspected through the depth-direction scanning.

While the scanner 140 is shown simply in FIG. 1, the scanner 140 may be implemented as various devices capable of controlling a focal point by moving in the depth direction. For example, the scanner 140 may be a piezoelectric scanner configured to provide precise movement by a piezoelectric effect. Alternatively, the scanner 140 may be implemented in a stage structure that vertically moves while supporting the optical system.

The detector 150 may be configured to detect, during the depth-direction scanning, a fundamental beam passed through the wafer 200 and the THG signals generated from the wafer 200. The detector 150 may be implemented as an image sensor, such as an electron-multiplying charge-coupled device (EMCCD). While the near-infrared wavelength signals are not directly detectable, the EMCCD may detect the near-infrared spectrum based on a nonlinear two-photon detection technique.

Referring to FIG. 3, the optical spectrum of the THG may be observed at 517 nm, which corresponds to one-third wavelength of the incident beam of 1550 nm. It may also be seen that the spectral bandwidth of the THG generated by the annular beam coincides with the spectral bandwidth of the THG generated by the Gaussian beam.

The computing device 160 may be configured to calculate a physical thickness d of the wafer 200 based on the distance d′ between two points at which the THG signal is detected during the depth-direction scanning. Here, the distance d′ may be referred to as an optical thickness. As shown in Equation 1, the physical thickness d of the wafer 200 may be calculated by converting the optical thickness d′, corresponding to a distance between third-harmonic generation positions, using an average ray incidence angle α and a refraction angle β. Since the annular beam incident on the wafer has a smaller deviation in ray incidence angles than a Gaussian beam, optical distortion is reduced, and, consequently, high-precision thickness measurement may be achieved through using Equation 1.

$$d = {d}^{′} \frac{tan ( α )}{tan ( β )} \qquad ( Equation 1 )$$

The THG signals are generated at the upper surface and the lower surface of the wafer 200. Due to refraction of incident rays on the wafer 200, refracted rays are focused at a point on the lower surface. Therefore, to detect the third-harmonic generation occurring at the upper and lower surfaces of the wafer 200, the focus is adjusted to the upper and lower surfaces. However, due to refraction within the medium, third-harmonic generation at the lower surface occurs at a position different from an actual physical depth. As a result, a difference arises between the optical thickness and the physical thickness, and the optical thickness may be converted into the physical thickness using trigonometry.

Meanwhile, since a focused Gaussian beam (see FIG. 2) has a wide range of incidence angles, rays refracted in the medium due to optical aberrations of the Gaussian beam are focused at slightly different positions depending on the incidence angles. Therefore, when the optical thickness is converted into the physical thickness by including all rays with different incident angles, as in Equation 1, an error may occur. To reduce such an error, the present disclosure uses an annular beam having a smaller deviation in ray incidence angles, instead of the Gaussian beam, thereby minimizing optical aberrations and consequently reducing errors and improving measurement precision. In addition, a high peak power for efficient third-harmonic generation may be obtained with a high numerical aperture.

The measurement range and resolution of the measurement system 100 may vary depending on a working distance of the objective lens 130 and an axial intensity width of the annular beam focused along an optical axis. Since the working distance limits a distance between the objective lens 130 and the lower surface of the wafer 200, a maximum measurable thickness may be determined. In addition, a range of third-harmonic generation at a surface is determined according to an axial intensity distribution of the focused beam and a power threshold of the THG signal, and a minimum measurable thickness may be determined according to the range.

Referring to FIG. 4, the computing device 160 may generate stacked images of the spatial power distribution based on intensity of the THG signal detected by the detector 150 through the depth-directed scanning. It may be observed that the intensity of the THG signal increases significantly at the interface between air and the medium at the lower surface of the wafer. Since the THG signal generated on the upper surface of the wafer is absorbed while traversing the wafer, stacked images of the THG signal generated at the lower surface may be generated.

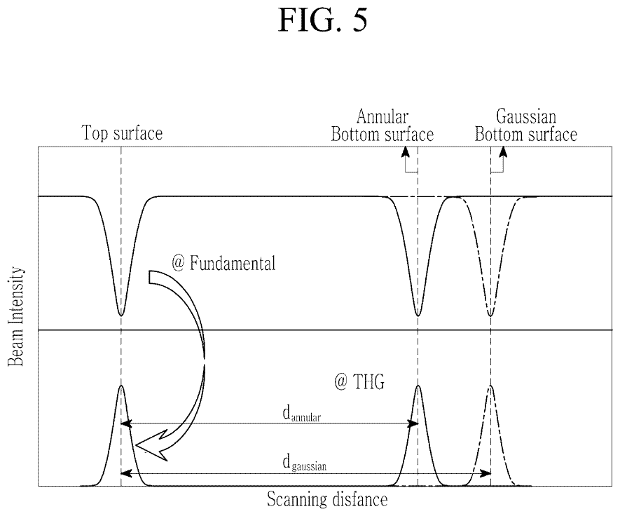

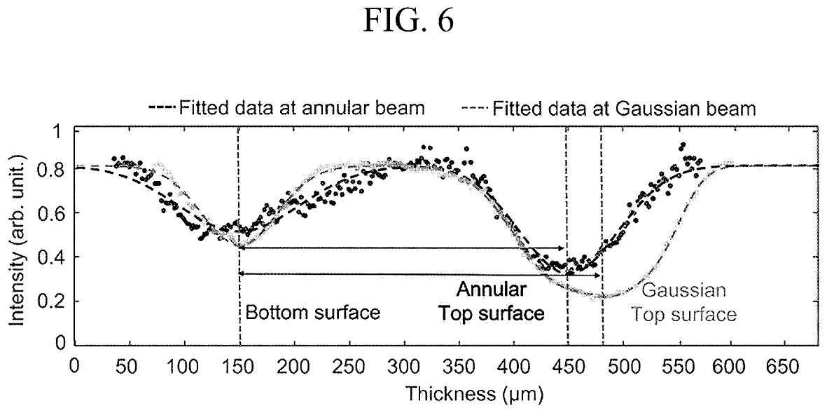

FIGS. 5 and 6 are diagrams illustrating signal intensity variations acquired through depth-direction scanning, according to an embodiment.

Referring to FIG. 5, when the intensity variation of the fundamental signal with respect to a scanning distance are observed, two intensity drops are identified at the fundamental wavelength. The two intensity drops correspond to the upper and lower surfaces where the fundamental photons are converted into third-harmonic photons. When the intensity variations of the THG signal with respect to the scanning distance are observed, the intensity increases due to the converted third-harmonic photons, contrary to the intensity variation of the fundamental signal. The wafer thickness may be extracted from a distance between peak positions of the THG signal intensity.

Referring to FIG. 6, when an experimentally obtained intensity of a fundamental beam through depth-direction scanning is observed, intensity drops are identified at two points similar to those shown in FIG. 5. The intensity of the fundamental beam decreases slightly after passing through the wafer, and such intensity loss varies depending on wavelength and may cause a slight change in a spectrum of the transmitted beam. However, since the spectral transmission difference only changes an internal phase of the beam without changing a pulse envelope, wavelength-dependent loss does not affect an extracted wafer thickness. The position of the third harmonic generation may be accurately determined through Gaussian fitting near the intensity drop positions. The optical thickness is determined as a distance between the two intensity drop positions.

To verify the measurement accuracy with different annular beams, optical thicknesses obtained using seven different annular beams may be converted into physical thicknesses according to Equation 1, and measurement results are shown in Table 1. The measurement results may be evaluated based on a deviation from a certified value of 299.9 μm provided by the Korea Research Institute of Standards and Science (KRISS), which is obtained using a contact-type thickness measuring device (HEIDENHAIN CT2501).

TABLE 1

| | | |
|---|---|---|
| Annular beam shape(ε) | measurement | Deviation |

| | | | | |
|---|---|---|---|---|
| 0.20 | 299.84 | μm | 0.07 | μm |
| 0.33 | 300.04 | μm | 0.13 | μm |
| 0.36 | 300.12 | μms | 0.21 | μm |
| 0.40 | 303.39 | μm | 3.48 | μm |
| 0.60 | 316.47 | μm | 16.56 | μm |
| 0.67 | 317.75 | μm | 17.84 | μm |
| 1(Gaussian beam) | 330.50 | μm | 30.59 | μm |

In Table 1, ε denotes a dimensional parameter of the annular beam and represents a ratio of a rim width of the annular beam to a radius of a Gaussian beam. When the rim width of the annular beam is sufficiently narrow (ε=0.2 and 0.33), it may be confirmed that a measured thickness approaches the certified value. For an annular beam having a rim width narrower than a predetermined threshold (ε=0.2), the thickness may be measured with an error of 0.07 μm relative to the certified value, which corresponds to a precise measurement result within an uncertainty range guaranteed by the Korea Institute of Standards and Science.

As shown in Table 1, as ε increases, a deviation between the measured value and the certified value increases. That is because, as ε increases, more inner rays are involved in the third-harmonic generation. Since the inner rays are refracted in the medium at a smaller angle than outer rays, a focal point of the inner rays at a surface of the medium is located farther than that of the outer rays. As a result, a thickness value measured using the inner rays is larger than an actual thickness value.

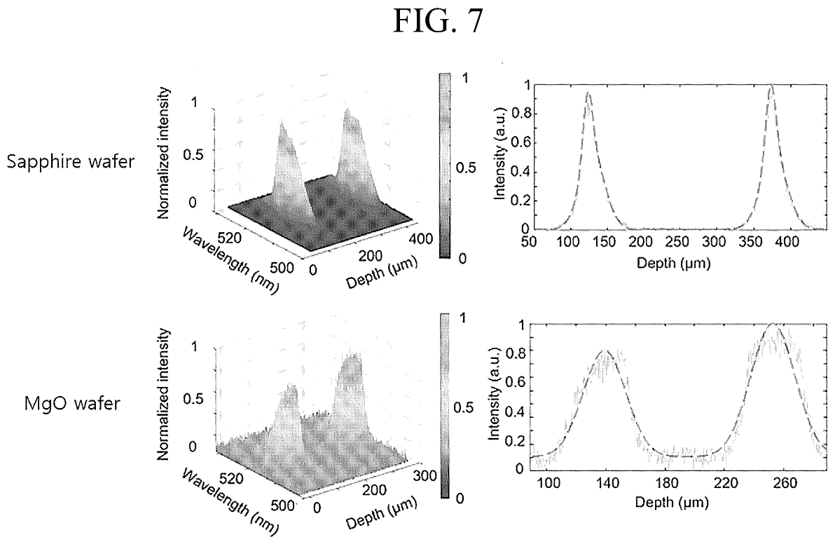

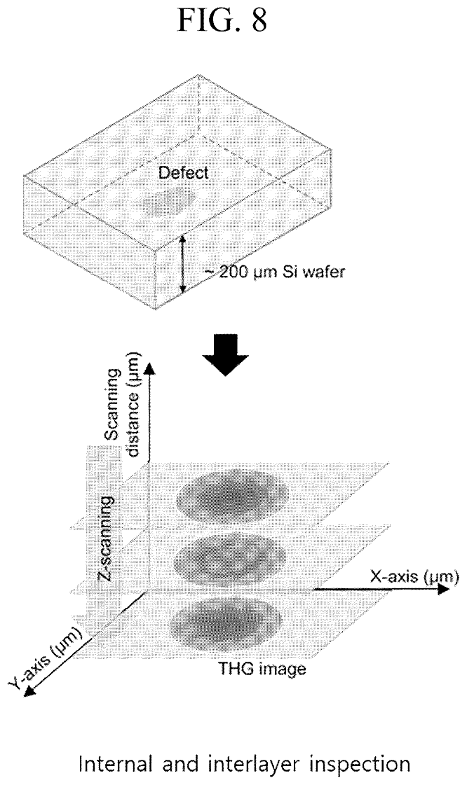

FIG. 7 is a diagram illustrating detection of third-harmonic generation signal for thickness measurement of sapphire and MgO according to an embodiment, and FIG. 8 is a diagram conceptually illustrating wafer inspection according to an embodiment.

Referring to FIG. 7, since third-harmonic generation is a nonlinear optical phenomenon, the thickness measurement described herein may be applied not only to silicon wafers but also to various optical materials such as sapphire and MgO.

For example, when thicknesses of sapphire and MgO wafers, which are known to be transparent to visible light, are measured using the proposed method, it may be observed that the transmittance of these wafers is high at the wavelength of a 520 nm THG signal, and that the THG signal generated on the upper surface pass through the wafer and directly observable. Based on the intensity and spectrum of the THG signal measured during the depth-direction scanning, the thickness of the corresponding wafer may be calculated, and it may be confirmed that the calculated thickness falls within an uncertainty range.

Referring to FIG. 8, various non-destructive internal and interlayer inspections may be performed in addition to thickness measurements on the detector 150. The measurement system 100 may non-destructively detect internal defects of a wafer through depth selectivity of third-harmonic generation, and by stacking intensity images of THG signal in the depth direction, wafer conditions such as delamination, particle contamination, cracks, and like may be effectively inspected.

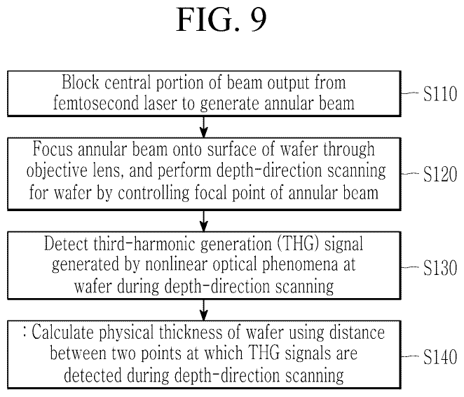

FIG. 9 is a flowchart illustrating a thickness measurement method according to an embodiment.

Referring to FIG. 9, the measurement system 100 blocks a central portion of a beam output from a femtosecond laser to generate an annular beam (S110). The annular beam may be generated using the optical mask 120. The center wavelength of the femtosecond laser beam may be determined according to a transmittance of a wafer. For example, a near-infrared (NIR) band (e.g., 1550 nm band) with high transmittance in silicon wafers may be used. When a rim width of the annular beam is sufficiently narrow, optical distortion may be reduced. The annular beam may be defined by a dimensional parameter ε, where ε represents a ratio of the rim width of the annular beam to a radius of the Gaussian beam.

The measurement system 100 focuses the annular beam onto a surface of the wafer through an objective lens, and performs depth-direction scanning for the wafer by controlling a focal point of the annular beam (S120).

The measurement system 100 detects third-harmonic generation (THG) signals generated by nonlinear optical phenomena at the wafer during the depth-direction scanning (S130). At the upper and lower surfaces of the wafer, fundamental photons are converted into third-harmonic photons, thereby increasing an intensity of the THG signal. The THG signal corresponds to one-third wavelength of the fundamental signal and is sensitively generated at the medium interface. The THG signal may be detected using an image sensor, such as an electron-multiplying charge-coupled device (EMCCD). The measurement system 100 may generate stacked images of a spatial power distribution based on intensity of the THG signal detected at respective depths through depth-direction scanning.

The measurement system 100 calculates a physical thickness of the wafer using a distance between two points at which the THG signals are detected during the depth-direction scanning (S140). The measurement system 100 may convert the distance between the two points where the THG signal is detected into the physical thickness using ray incidence angle and refraction angle. In addition to thickness measurement, the measurement system 100 may inspect the wafer for defects, delamination, particle contamination, cracks, and the like, using the THG signal intensity images stacked in the depth direction.

As such, according to some embodiments, the present disclosure addresses the limitations of conventional wafer thickness measurement technologies, such as insufficient depth selectivity, system complexity, and limited measurement accuracy, and provides non-destructive and high-precision measurement of semiconductor substrates like silicon wafers.

According to some embodiments, nanometer-scale high-precision measurement may be achieved through third-harmonic generation using a near-infrared femtosecond laser. The present disclosure may improve surface sensitivity, thereby enabling effective wafer inspections of defects, delamination, particle contamination, cracks, and the like. Accordingly, the present disclosure may be effectively applied for quality control and internal defect diagnosis in semiconductor manufacturing.

According to some embodiments, the non-destructive and non-contact thickness measurement may prevent substrate damage, and in-line measurement may improve the efficiency of production processes.

According to some embodiments, system optimization with an annular beam design may reduce optical distortion to improve measurement precision and reproducibility. This versatility may extend the application of the technology beyond silicon wafers to various optical materials such as sapphire and MgO.

According to some embodiments, the present disclosure may significantly contribute to quality control and productivity improvements in semiconductor manufacturing processes.

The embodiments of the present disclosure described above are not implemented only through devices and methods, but may also be implemented through a program that realizes a function corresponding to the configuration of the embodiments of the present disclosure or a recording medium on which the program is recorded.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

What is claimed is:

1. A measurement system, comprising:
a femtosecond laser;
an optical mask configured to block a central portion of a beam output from the femtosecond laser to generate an annular beam;
an objective lens configured to focus the annular beam onto a measurement target;
a scanner configured to perform depth-direction scanning of the measurement target by controlling a focal point of the annular beam;
a detector configured to detect third-harmonic generation (THG) signals generated from the measurement target during the depth-direction scanning; and
a computing device configured to calculate a physical thickness of the measurement target using a distance between two points at which the THG signals are detected.

2. The measurement system of claim 1, wherein the computing device is configured to
convert the distance between the two points at which the THG signals are detected into the physical thickness using a ray incidence angle and a refraction angle.

3. The measurement system of claim 1, wherein the computing device is configured to
generate stacked images based on intensity of the THG signals detected through the depth-direction scanning.

4. The measurement system of claim 3, wherein the computing device is configured to
inspect internal defects of the measurement target using the stacked images.

5. The measurement system of claim 1, wherein the annular beam is designed according to a ratio of a rim width to a radius of a Gaussian beam.

6. The measurement system of claim 1, wherein a center wavelength of the femtosecond laser is determined according to a transmittance of the measurement target.

7. The measurement system of claim 6, wherein, when the measurement target is a silicon wafer, the femtosecond laser outputs a beam in a near-infrared (NIR) band.

8. A wafer measurement method, comprising:
blocking a central portion of a beam output from a femtosecond laser to generate an annular beam;
focusing the annular beam onto a surface of a wafer and performing depth-direction scanning of the wafer by controlling a focal point of the annular beam;
detecting third-harmonic generation (THG) signals generated from the wafer during the depth-direction scanning; and
calculating a physical thickness of the wafer using a distance between two points at which the THG signals are detected.

9. The wafer measurement method of claim 8, wherein the calculating the physical thickness comprises
converting the distance between the two points at which the THG signals are detected into the physical thickness using a ray incidence angle and a refraction angle.

10. The wafer measurement method of claim 8, further comprising:
generating stacked images based on intensity of the THG signals detected through the depth-direction scanning.

11. The wafer measurement method of claim 10, further comprising:
inspecting internal defects of the wafer using the stacked images.

12. The wafer measurement method of claim 8, wherein the annular beam is designed according to a ratio of a rim width to a radius of a Gaussian beam.

13. The wafer measurement method of claim 8, wherein a center wavelength of the femtosecond laser is determined according to a transmittance of the wafer.

14. The wafer measurement method of claim 13, wherein, when the wafer is a silicon wafer, the femtosecond laser outputs a beam in a near-infrared (NIR) band.
